(19) United States
(12) Patent Application Publication
(10) Pub. No.: US 2008/0250991 A1
(43) Pub. Date: Oct. 16, 2008

(54) Revegetation Process

(76) Inventor: Fred Werth, Santa Fe, NM (US)

Correspondence Address: GREENLEE WINNER AND SULLIVAN P C, 4875 PEARL EAST CIRCLE, SUITE 200, BOULDER, CO, 80301, US

(21) Appl. No.: 11/571,565

(22) PCT Filed: Jul. 1, 2005
(86) PCT No.: PCT/US2005/023773

§ 371 Date: Feb. 22, 2008

Related U.S. Application Data
(60) Provisional application No. 60/585,144, filed on Jul. 1, 2004.

(51) Int. Cl. A01C 7/08; A01C 15/00

(52) U.S. Cl. 111/130

(57) ABSTRACT

A method for revegetation or remediation of a land surface in which a layer containing selected seed, mulch and nutrients is applied to the land surface. More specifically, the layer applied contains grain seed, grass seed or both and the rate of seeding is preferably 100 lbs/acre or more. The method preferably includes after-care steps in which growth stimulating or growth maintenance compositions are applied to the land that has been seeded using the layer application.

### CROSS-REFERENCE TO RELATED APPLICATIONS

This application claims the benefit of U. S. Provisional Application No. 60/585,144, filed Jul. 1, 2004, which is incorporated by reference in its entirety herein.

### BACKGROUND OF THE INVENTION

This invention relates to methods and materials for revegetation and remediation of land that is barren or sparsely vegetated, rocky, eroded and/or having little or no top soil. The methods and materials are particularly well-suited, for example, to areas that have been subjected to strip mining or to areas containing mine tailings. The materials and methods of the invention are also useful in the regeneration of overgrazed areas. The methods and materials of this invention are further useful in areas where vegetation has been detrimentally impacted by industrial activity, the release or accumulation of toxic materials (e.g., heavy metals, i.e. uranium tailings), oil spills, chemical spills and the like.

The method, at least in part, is based on the creation of a “biological event,” a rapid and intense generation of plant material, to generate a land surface that is more amenable to the growth of plants, grasses, shrubs and trees. The method also involves an aftercare scheme in which growth stimulating and growth maintenance compositions are selectively applied periodically, preferably using foliar spraying, to the regenerating plants to facilitate establishment of stable vegetation.

Various methods and materials have been described for revegetation of land. Methods which provide for the establishment of stable vegetation and which are efficient with respect to cost, time and labor are of significant interest. Further, methods which can be successfully employed for the revegetation of land that is in arid or semi-arid climates are of particular interest.

U.S. Pat. No. 4,297,810 relates to a sprayable mulch for use in soil reclamation which comprises hay, paper, binder and coloring agent in certain amounts and to which seed can be added. The hydromulch is said to be effective in reclaiming land and particularly useful in planting seed to establish ground cover on reclaimed strip mining areas.

U.S. Pat. No. 5,323,720 relates to a revegetation method which employs dispensing of grass, forb and shrub seed with a seed drill wherein at least one cool season grass species is dispensed. Companion crops of annual grain are seeded with native grass, forb and shrub seed and mowed prior to seedhead maturity to prevent reseeding and provide cover and protection for native seedlings. The method is reported to be particularly adapted for revegetation of semi-arid lands.

U.S. Pat. No. 5, 695,301 relates to a method of controlling erosion and creating a growth medium to support plant life which is based on placing animals on the site to be ameliorated. The method requires an initial analysis of the site to determine the type and amount of mulch to be applied to the site and the length of time for placing the animals on the site to produce conditions suitable for generation of a plant growth medium, such as soil on the site. The method also relates to the control of the location and movement of animals on the site to optimize the generation of growth medium.

U.S. Pat. No. 5,884,570 relates to a method for rapid propagation of grass and other plants using a sod slurry. The sod slurry is formed by mixing sod containing grass or other plants with water, fertilizer and a slicking agent. The sod slurry is sprayed or poured onto a prepared area of land.

U.S. Pat. No. 6,228,136 relates to the use of cyanobacteria inoculants to reclaim land and reduce soil erosion.

U.S. published patent application 2003/0031511. published Feb. 13, 2003, relates to devices, systems and methods for among other things controlling erosion and establishing vegetation which employ compost-filed mesh tubes.

There is a continuing need in the art for methods and materials useful for the revegetation and reclamation of land.

### SUMMARY OF THE INVENTION

This invention relates to methods and materials for revegetation and remediation of land which may be applied to land that is barren or sparsely vegetated, rocky, eroded, or having little or no top soil, to areas that have been subjected to mining or other detrimental industrial activities, to areas that have been subjected to the release or accumulation of toxic materials, and to areas that have been overgrazed. The method employs the application of a layer containing grain seed or grass seed or a combination of such seed to generate a beneficial “biological event,” which is a rapid and intense generation of plant material, to generate a land surface that is after this initial growth event more amenable to the growth of other plants, grasses, shrubs and trees. The method optionally involves an aftercare scheme in which growth stimulating and growth maintenance compositions are selectively applied periodically, preferably using foliar spraying, to the plants in the area being revegetated to facilitate establishment of stable vegetation.

The method involves application or formation of a layer on the land surface which comprises a selected composition of grain seed, grass seed or a mixture of both grain and grass seed. Additional seed for plants, forbs, shrubs and trees appropriate for use in the area to be treated can be added to the layer. The layer also contains mulch and selected nutrients for the plants that will be generated from the seed. The layer may contain fertilizer or other materials beneficial to plants or stimulating to plant growth. The method can include selection of native grasses appropriate for the area and climate of the location which is to be remediated or reclaimed. The seed of such native grasses can be included in the applied layer. In specific embodiments, a combination of native grass and a rapidly growing grain such as barley is employed. After formation of the initial seeding layer, an after-care protocol is optionally, but preferably applied to the site. The after-care protocol involves application of growth stimulating and growth maintenance compositions to the site where the layer has been created. These compositions are periodically applied as needed, and are preferably applied as foliar sprays. The use of foliar sprays in after-care is believed to provide additional benefit in amending and improving the soil for plant growth. Application of after-care is continued periodically, for example by alternating applications of growth stimulating and growth maintaining compositions, until a desired level of growth is obtained, preferably after care is continued until stable vegetation is obtained on the site.

In a specific embodiment the seed contained in the first layer is applied at a rate of 100 lbs/acre or more. More preferably, the concentration of seed in the layer is greater than 100 lbs/acre. In specific embodiments, the seed is a mixture of seed of different plants, but predominantly contains grain seed and the grain seed is preferably barley seed. In specific embodiments, the seed contains native grass seed and in other embodiments the seed is native grass seed. In specific embodiments the seed in the layer is predominantly native grass seed.

The initial step of application of the seed layer may be repeated one or more times as considered necessary to obtain a desired coverage layer. The material being applied may contain a colorant which indicates its presence and can be used to identify the area that has been treated. The layer applied may contain one or more gibberellins, one or more humates or a mixture thereof. The layer applied may contain seaweed to provide plant nutrients.

Mulch in the layer may be straw, hay, cut native grass or mixtures thereof. In general, any material, particularly a fibrous material, known to be useful as mulch can be employed as mulch in the applied seed layer. The layer may be applied by spraying a hydromulch containing selected seed as described herein.

A growth stimulating composition may be applied to the layer at one or more selected times after the layer is formed. The layer as initially applied may itself contain plant growth stimulants such as gibberellins. A growth maintenance compositions may be applied to the layer at one or more selected times after the layer is formed. The layer as initially applied may itself contain one or more components of the growth maintenance compositions.

The layer may contain tree seeds or trees may be planted in the area treated before or preferably after the layer is applied. In one embodiment, trees are introduced into the layer shortly (within weeks or a few months) after the layer is applied. In an embodiment, trees are planted in the area treated by application of the layer after grass and/or grain plants have grown to maturity. In an embodiment, trees are planted in the area treated by application of the layer after a full growth season of the initial grass and grains obtained from seeds in the layer.

Additional aspects and embodiments of the invention will become apparent on review of the detailed description of the invention which follows.

### BRIEF DESCRIPTION OF THE DRAWINGS

(Not applicable)

DESCRIPTION OF THE INVENTION

This invention provides a revegetation or remediation method for land surfaces comprising the steps:
(a) applying a layer containing a selected composition of grass seed, grain seed or both, mulch, and selected nutrients to the land surface;
(b) periodically applying to the layer one or more growth stimulating compositions which comprise selected nutrients and plant growth factors;
(c) periodically applying to the layer a growth maintenance composition comprising nitrogen and optionally comprising other selected nutrients, but containing no plant growth factors;
   wherein the application of step (a) is repeated until a desired level of surface coverage of growing grass, grain or both is achieved and wherein steps (b) and (c) are repeated on an alternating basis to achieve a desired level of growth.

In preferred examples, the initial seeding layers are applied by spraying an aqueous slurry containing seeds, mulch and nutrients. In preferred examples, the periodic applications of growth stimulating compositions and growth maintenance compositions are made by foliar spraying. In preferred examples, growth stimulating after-care compositions are generally applied more frequently than growth maintenance after-care formulations which contain nitrogen. In specific preferred embodiments, growth maintenance after-care formulations are applied once for every 3 or 4 applications of growth stimulating after-care formulations. After-care formulation applications are performed as needed or desired to maintain and or enhance growth of initially seeded plants and may be continued after planting of secondary plants, shrubs and/or trees. For example, growth maintenance formulations containing nitrogen may be applied when visual inspection of the treated area shows yellowing of the plants. Nitrogen-containing compositions are preferably not applied to the treated area at the same time as growth stimulating formulations. After-care formulations can, for example, be applied on a weekly, biweekly, monthly, bimonthly, after initial seeding. More preferably after-care formulations are applied on a biweekly or monthly schedule.

After-care is preferably applied for a time sufficient to ensure stable vegetation. The length of time of after-care depend will depend upon the nature of the site with rocky, eroded, contaminated areas or areas with little top soil generally requiring longer after care than areas which are sparsely vegetated and or overgrazed. Preferably aftercare is continued for at least one year and more preferably, dependent on soil condition, for three or more years.

The continued application and application schedule for after-care formulations will depend at least in part on the climate. For example, applications may made less frequently during winter months dependent upon the climate of the area being revegetated. The timing of the initial seeding application will also depend at least in part on climate of the area being revegetated, in Northern latitudes for example, initial seeding will preferably be done from early Spring through Fall. However, initial seeding can more generally be applied at any time of the year which will allow for germination and preferably seedling development. The seed composition employed for initial seeding can be adjusted to be more suitable for seeding during different seasons. For example, more cold hardly seed can be employed if seeding is performed during the colder seasons.

Generally, after-care begins within one to two weeks after the initial seeding layer is applied. However, after-care can be delayed in certain circumstances. For example, if seeding is performed in the late fall or winter, after-care may be delayed until seeds begin to germinate. It may be necessary or beneficial to adjust after-care schedules to changes in weather conditions, for example, after-care may be delayed due to heavy rains, snow, cold or other weather conditions. The frequency of after-care applications will generally be higher during the local growing season than during times of plant dormancy. Additionally, the frequency of after-care applications will depend generally upon the types of seeds employed in the seeding layer.

The method of this invention can be practiced in general on any terrain, including sloped and rocky areas, and is particularly useful in areas having little or no top soil. The methods are more generally applicable on land that has on average less than about 3 feet of top soil. In a specific embodiment, the methods and materials of this invention can be applied to overgrazed land which may for example sparse grass or similar plants, but which may have growing trees and shrubs.

The land surface to be treated is optionally furrowed or scored prior to application. Seed drills and or seed drilling methods may be applied, but are not preferred. The land to be treated may be graded prior to treatment.

Seeding compositions are preferably applied as a slurry. The seeding composition is typically prepared as an aqueous slurry which may be poured or sprayed on the land surface. Mulch is preferably a component of the slurry to be poured or sprayed, but may alternatively or in addition, be provided as a separate layer or layers. For example, a bottom mulch layer may be applied to the land surface, followed by application of the slurry containing seed, and application of a top mulch layer. Multiple alternating layers of mulch and seeds can also be employed. A layer of hay straw or other fiber may be applied over the slurry or mulch layer to provide protection thereto.

Artificial irrigation, through use of an irrigation system (drip or spray) or by mechanical or manual spraying or drip application of water, can be combined with the steps of this method as appropriate for the location.

Seeds included in the seeding composition or later seeded into the developing revegetated area may be pre-treated chemically, by application of mechanical abrasion (scaring), or by application of changes in temperature (cold treatments) or any other known method for improving seed germination. Pre-treated seeds appropriate for use in the methods herein are available from commercial sources. Late fall or winter seeding (dependent upon location and climate) may provide for increased germination rates of certain seeds.

An important aspect of initial seeding applications is the use of a high loading of seed. For most revegetation/remediation applications at least 100 lbs of total seed/acre should be applied. Preferred total seeding rates are 150 or more lbs/acre and more preferred seeding rates are 200-400 lbs/acre. Seeding rates greater than 400 lbs/acre may be employed, but are generally not preferred due to increased cost. High seeding rates are employed to facilitate the creation of a layer of plant material, including dead plant material, on the land surface to create a “biological event” to provide an improved environment for growth of surviving plants, seeds in later seed applications, seeds in the area prior to seeding and/or adventitious seeds which enter the treated land after initial seeding.

More specifically, the initially applied seed mixture comprises seed of one or more grains or one or more native grasses or a mixture thereof. Preferred grains for inclusion in the initial application(s) are barley, oats, rye and mixtures thereof. The more preferred grain for initial applications is barley which achieves the most rapid development of plant surface coverage. Native grasses are selected for use in the location being revegetated. Preferably native grasses that exhibit rapid growth in the location are preferred. In a specific embodiment, the initially applied seed mixture comprises a mixture of grain seed and native grass seed. The initial seeding mixture may also include wild flower seed selected as appropriate for the location. Blue Flax, Mexican Hat, and Prairie Cone Flower are suitable wild flower seeds for inclusion in seed mixtures for use in the Southwestern United States. Wild flower mixtures appropriate for use n various locations are commercially available. Information concerning wild flower seed appropriate for use in a given location is readily available in the art.

The initial seeding mixture may contain seeds for forbs, shrubs and/or trees. Additionally shrubs and/or trees may be planted in the area using methods known in the art after the layer has been applied.

In a specific embodiment, the seeding mixture comprises a predominate (50% or more by weight) native grass seed selected for rapid growth in the region being treated. More preferred seed mixtures are those which contain a predominant native grass seed in combination with minor amounts of a variety of other native grass seeds. For applications in the U.S. Southwest, an exemplary predominate native grass is Blue Grama which is tolerant to drought, high winds and arid climate.

Specific seed mixtures include those in which 50% or more by weight of Blue Grama seed are combined with seed of one or more native grasses including Sideoats Grama, Little Bluestem, or Galetta. Information is readily available in the art concerning native grasses suitable for use in various locations and climates. Seeds or seed mixtures of appropriate alternative plants which are tolerant to the climate conditions of the selected area to be revegetated can be readily selected employing such information. Wild flower seed may be incorporated into seeding mixtures, typically in relatively minor amounts (1-25% by weight).

In specific embodiments, the initial seeding mixture contains more than 50% by weight of grain seed. The application seed mixture can contain from about 80% to 100% grain seed. In a specific example, the application seed mixture contains less than 50% by weight of native grass seed. In other specific examples, the application seed mixture contains from about 5-20% by weight of native grass seed and from about 80-95% by weight of grain seed. In other specific examples, the application seed contains from about 5-20% by weight of native grass seed and from about 80-95% by weight of barley.

In specific embodiments, the initial seeding mixture contains from about 80% to 100% of a predominant native grass seed (e.g., Blue Gamma seed). In a specific example, the seed mixture contains less than about 20% by weight of native grass seed other than the predominant native grass seed. In other specific examples, the seed mixture contains from about 5-20% by weight of native grass seed other than the predominant native grass seed. In other specific examples, the seed contains from about 75%-95% by weight of the predominant native grass seed, from about 1% to about 20% by weight of wild flower seed with the balance of the mixture being native grass seed other than the predominant native grass seed.

The initial seeding mixture may also contain seeds of pioneer plants, shrubs and trees (i.e., pioneer seeds) appropriate for the location that is to be revegetated and/or remediated. The term pioneer is applied to plants (including trees and shrubs) which are capable of invading sites lacking vegetation, such as newly exposed soil and persisting there until supplanted by succeeding species. For example, pioneer plants are the first plants to grow in an area after a major disturbance of vegetation through fire, harvest or the like. In general, the initial seed mixture will contain only a minor component of such pioneer seed.

Optionally, seeds, seedlings or more mature plants, shrubs and trees (including pioneer plants) can be introduced or planted in the treated area once the desired coverage of grass and/or grain is achieved.

It is believed that the addition of trees and/or shrubs to the treated area can provide significant benefit for the improvement of the soil and revegetation of the area treated. In particular it is believed that foliar applications of nutrients beneficial for plants, including for example trace metals, nitrogen etc., to plants, trees or shrubs growing in the area functions to amend the soil and improve the ability of the area treated to support plant growth.

In another specific embodiment, particularly applicable to land that has been overgrazed, seeds of cash crops can be included in the initial seeding mixture or seedlings of such crops can be planted in the treated area after initial seeding application. Exemplary cash crops which could be established using the methods herein include hardwoods, such as black walnut, ash, birch, cherry, oak and poplar, among others.

Mulch employed in this invention can be organic or inorganic. Mulch is preferably biodegradable. Mulch for use in the initial seed applications, for example, can comprises plant matter, including hay, straw, cut grass, shredded wood, bark or paper, wood or bark chips, saw dust, leaves, leaf mold. Preferred mulches include paper products, hay, straw, cut native grass and mixtures thereof. Mulch is selected as appropriate for the land surface to be treated to generally remain in place were applied, as appropriate for the means employed for applying the initial seed applications and in general to minimize cost. Clay can be added to mulch material. In a specific embodiment, the mulch employed comprises magazine stock which typically contains about 60% by weight clay and 40% by weight tree fiber.

In another specific embodiment, the mulch employed is newspaper, magazine stock or a mixture thereof. Mulch provides a substrate for retaining nutrients and waters and protection for seeds, sprouts and seedlings during initial applications and during initial seedling development. Addition or inclusion of clay in the mulch facilitates adhesion of mulch. Clay can be included in mulch in an amount ranging from about 1% up to about 70% by weight. Mulch can also provide a suitable environment for the development of microbial floral beneficial for the growth of selected plants, shrubs or trees. Mulch may be replenished as is needed or considered desirable after initial seed applications.

The initial seeding composition comprises nutrients including a nitrogen source, a phosphorous source, and humates, particularly humates containing fulvic acid. Nitrogen and/or phosphorous can be provided through use of a commercial fertilizer. Commercial fertilizers are also available that provide humates in addition to nitrogen and/or phosphorous. Additional plant nutrients, including among others, amino acids, trace minerals, and/or selected metal ions can also be added to the initial seeding composition. Sources of nitrogen, phosphorous, humates, amino acids, trace minerals and or other metal ions appropriate for use in application to soil for growth of plants or to plants are known in the art. Selected metal ions may be particularly beneficial, if the land to be revegetated is found to be deficient in a beneficial metal. The concentration of nitrogen, phosphorous and humates in formulations herein is adjusted to avoid levels detrimental to plant growth. Application of nitrogen to plants that are under stress should be minimized or avoided. The concentration of metal ions in formulations herein is adjusted to avoid levels of metals detrimental to plant growth. In general, nutrients or a combination of nutrients in the initial seeding mixture can be selected based on soil analysis or through the analysis of plants existing at the revegetation site to supplement soil deficiencies.

After-care compositions can also include humates, and nutrients including amino acids.

Commercially available humate compositions including Humasol, a water-soluble Leonardite (Agricare, Inc, Amity Oreg.), and Humasolve (™, Bioag Corporation, Honaunau, Hi.) can be employed in the initial seeding composition and after-care compositions.

Fish emulsion and chicken and fish manure can be employed in the initial seeding compositions and/or in after-care compositions as a nitrogen source. These materials may also provide a food source for microorganisms beneficial to plant growth. An exemplary, useful chicken and fish manure is available from Hallier Corp. (Vermillion, Kans.) under the tradename Bioform. Another useful nitrogen source is fish protein hydrolysate also available from Hallier Corp. under the tradename Bioform FPH 8-8-8. This material also contains seaweed extracts which are a source of trace minerals as well as plant growth factors (gibberellins).

The initial seeding composition and after-compositions herein can optionally include silicic acid. Humasolve (Bioag Corp.) is a commercial source of humates and silicic acid.

The initial seeding composition optionally includes plant growth factors such as gibberellins. Preferred plant growth regulators for use in the seeding composition are one or more gibberellins. The seeding composition may include one or more gibberellins or mixtures thereof. Gibberellins (designated individually as Gibberellin Ax, where x is an integer) are a group of diterpenoid acids that function as plant growth regulators. At least 126 gibberellins are known in the art. Gibberellins are available in various forms from commercial sources. Gibberellins can be provided from natural sources, such as seaweed, particularly kelp. Seaweed can also provide a source of trace minerals beneficial for plant growth.

Commercial products are generally employed in compositions herein in the amount or amounts recommended by the manufacturer except as otherwise noted.

Growth maintenance compositions comprise one or more nitrogen sources and optionally contain phosphorous, humates and a selection of plant nutrients. Growth maintenance compositions do not contain any significant amount of plant growth factors, such as gibberellins. Plant nutrients include among others one or more amino acids, one or more beneficial metal ions, and/or a mixture of trace metals.

Growth stimulating compositions comprise one or more plant growth factors, e.g., gibberellins, and optionally comprise phosphorous, humates, and plant nutrients, such as amino acids. Gibberellins can be provided for example in seaweed extract.

The methods of this invention can be combined with inoculation with beneficial microorganisms, particularly in the form of inoculants. Inoculants may contain a selected type of beneficial organism (e.g., fungus or bacteria) or a beneficial mixture of microorganism. Inoculants typically contain, live or dormant microorganisms (e.g., living cells, spores, etc.) in a selected carrier which may be inert or which provides a food and/or nutrient source for the microorganism. Inoculants may contain a single type or species of microorganism or may contain a mixture of two or more microorganisms. Inoculants are selected for a given application as is known in the art. Further, microorganisms may be selected by art-known enrichment methods for a given application. Inoculants may be selected as beneficial for plant growth (e.g., for providing a growth stimulator or for providing a needed element, such as nitrogen). In applications to remediation where there is an undesired level of a pollutant or contaminant, such as oil or chemicals, inoculants can be selected based on the ability of the organisms therein to degrade or facilitate the degradation of the oil or chemical or simply based on the ability of the organisms to survive the ambient conditions. Inoculants may be combined in one or more of the initial seeding applications. Inoculants may be applied after the initial seeding layer is applied, to the layer of growing grasses/grains anytime thereafter or when additional plants, seedlings or trees are planted in the revegetating area.

The initial seedling mixture may also be provided with selected microbial nutrients to enhance selective growth of desired microbial flora.

An exemplary beneficial innoculum for use in seeding and after-care compositions is a micorrhizal innoculum, such as those available from Reforestation Technologies International (Salinas, Calif.). Micorrhizal innoculum is beneficially combined with silicic acid.

While the application of step a, above, alone or more typically in repeated applications of step a, may result in revegetation of eroded or rocky land surfaces, aftercare applications are considered to be important for achieving more rapid, stable revegetation. Aftercare applications of growth stimulation compositions and growth maintenance compositions are continued as long as desired or practical and preferably until stable revegetation is achieved. Stable revegetation includes the establishment of vigorous ground cover of grains, native grasses, and/or shrubs and/or trees at coverage levels appropriate for the terrain and climatic conditions that has a high likelihood of maintaining its growth level over time without further treatment.

The methods of this invention can be combined with plant treatment methods which employ the application of high frequency sound waves as described in U.S. Pat. Nos. 4,680,889; 4,834,789; 5,043,009 of Carlson or as provided in commercially available products by Carlson or others under the tradename Sonic Bloom (™). Each of these three U.S. patents are incorporated by reference herein for a description of these plant treatment methods and means for subjecting plants to sound waves of appropriate frequency. Products available under the tradename Sonic Bloom (™) are useful in the seeding compositions and after-care compositions herein and do not require the use of sound waves to provide beneficial effect. Application of such compositions alone or preferably in combination with methods for application of sound waves and in combination with the methods herein are found to generally provide increased growth rate of plants and increased generation of biomass to support revegetation and remediation. Plant growth stimulating compositions and plant growth maintenance compositions herein can be applied as described in the patents or in Sonic Bloom™ product literature with accompanying exposure of plant to sound waves. Additional information about current methods of application of sound waves for plant growth enhancement can be found at the web site: www.sonicbloom.com. Product literature is also available from Dan Carlson Scientific Enterprises, Inc (River Falls, Wisc.).

Initial seeding compositions and after-care formulations can optionally include one or more biodynamic preparations. Nine biodynamic preparations were described by R. Steiner for enhancing soil quality and/or stimulating plant growth. In general, the formulations consist of mineral, plant, or animal manure extracts, usually fermented and applied in small amounts (highly diluted) to soil, or onto plants or to prepare compost for use in farming. Original biodynamic (BD) preparations are numbered 500-508. The BD 500 preparation (horn-manure) is employed as a soil spray to stimulate root growth and humus formation. The BD 501 preparation (horn-silica) is made from powdered quartz and applied as a foliar spray to stimulate and regulate growth. BD 502-507 are used in making compost and can be combined with BD 500 or BD 501 for application to soil and/or plants. BD 508 is prepared from the silica-rich horsetail plant (Equisetum arvense) and used as a foliar spray to suppress fungal diseases in plants. Biodynamic preparations are available from commercial sources or can be prepared by methods that are widely known in the art. One commercial source of biodynamic preparations is the Josephine Porter Institute (JPI, Woolwine, Va.). Dilutions for application of biodynamic preparations are prepared as known in the art and as described by commercial providers. In specific embodiments, initial seeding compositions can include one or more of BD 500-507 in an amount effective for use as described by commercial providers, such as JPI. In more specific embodiments, initial seeding compositions can include BD 500 and/or BD 501. In other specific embodiments, initial seeding compositions can comprise compost prepared using biodynamic preparations. Biodynamic preparations can also be applied as a part of after-care.

Biodynamic preparations or compost prepared using biodynamic preparation may be employed in combination with the methods herein. For example biodynamic compost may be applied to the land prior to or after seeding. Alternatively biodynamic compost can be included in the seedling composition. Biodynamic compositions prepared as indicated by the commercial supplier containing BD 500 and/or 501 can be sprayed on the test area as an additional after-care step. Such applications would be at a level of about 2 gallons/acre. The frequency of application would be about 2-3 times in the growing season.

### THE EXAMPLES

An exemplary application of the methods of this invention is revegetation of coal-mining sites. In a specific example, a coal mining site near Madrid, N.Mex. was treated using methods herein. The small test site (about 0.25 acres) exhibited no new growth of grass and exhibited soil erosion, particularly in the form of rills (erosion streams). The test site received only an initial seed application in July. No artificial irrigation was supplied and in this case preferred after-care was not employed. The area of the test site under severe drought conditions during the test period. The test site was visually inspected about four months after treatment. New growth of grass was observed and rill development was noted to be arrested. The test site was visually inspected about nine months after initial treatment (the next Spring). New grass growth was again observed and continued inhibition of erosion rill development was noted.

The initial seeding composition contained a mixture of native grass seed. More specifically a mixture of Blue Grama seed (the predominant native grass seed) in combination with a commercially available mixture of native grass was employed (Santa Fe Trail Mix, Cutis and Curtis, N.Mex.). The commercial mixture is believed to contain Sideoats Grama, Galetta, and Little Blue Stem seeds. Mixed wild flower seed was also added to the seeding mixture. Wild flower seed added included Blue flax seed, Mexican Hat seed and Prairie Cone Flower seed. Thirty pounds of Blue Grama seed was combined with about 2-3 lbs of mixed native grass (other than Blue Grama) and with about 2-3 lbs of wild flower seed.

A seedling slurry suitable for 0.25 acre was prepared by combining 1000 gal of water with 200 lbs of magazine stock (about 60% by weight clay) with about 100 lbs of seed mixture. Also added to the seedling mixture were a quart to 0.5 gal Sonic Bloom (™, Dave Carlson Enterprises) a composition recommended for foliar spray applications, 10 lbs of micorrhizal innoculum (Reforestation Technologies International), and approximately 2 cups of Humisolve USA (™) Ion 14 (a combination of silicic acid and activated humic compounds).

The Sonic Bloom composition employed is understood to contain potassium, phosphorus, trace elements (sixty-four trace elements derived from natural plant products and from seaweed), gibberilic acid (from rice roots), chelated amino-acids and growth stimulants. Sonic Bloom compositions do not contain significant levels of nitrogen. Nitrogen may be supplied in addition to the Sonic Bloom, if so desired, by addition of a nitrogen source such as fish emulsion.

The seedling slurry was generally uniformly sprayed over the 0.25 acre test site.

After-care applications were not applied in the above revegetation test, however, application of growth maintenance and growth stimulating compositions as described herein can provide significantly improved revegetation results as assessed by plant growth (i.e., of grasses) and or by inhibition of erosion assessed by various means known in the art.

Exemplary after-care compositions include:

A first growth stimulating composition comprising gibberellins, amino acids and trace elements, such as provided in Sonic Bloom (™) which can be used typically in amounts as recommended by the manufacturer for foliar sprays or at somewhat higher concentrations. This growth stimulation composition is the most frequently applied after-care composition. Typical applications are weekly or biweekly after seeding (application frequency may be decreased based on climate or other conditions as discussed above.) Applications may be increased or decreased in frequency based on visual observation of the status of the growth in the treated area.

A second growth stimulating composition comprising Humisolve Ion 14 (in recommended amounts) and a micorrhyzal innoculum in recommended amounts. This composition is less frequently applied and typically is applied on once a month or several times during the growing season. This composition may be applied in place of or in combination with the first growth stimulating composition.

A growth maintenance composition comprising a nitrogen source, e.g. as provided by fish emulsion, chicken/fish manure or the like. The composition may also contain nutrients (e.g., amino acids, phosphorous, trance elements, metal ions), but does not include any significant amount of plant growth factors. The concentration of nitrogen source in the composition is as recommended by the manufacturer for foliar applications. However care must be taken in application to avoid application of detrimentally high amounts of nitrogen. This composition is the least frequently applied after-care composition and is typically applied once for every three to four applications of the first and/or second growth stimulating composition. However, this composition may alternatively be applied only when visual inspection detection yellowing of the plants indicative of the need for nitrogen application.

In preferred embodiments, compositions for foliar application by foliar spraying are pH balanced between pH 6-8.

Foliar application of growth stimulating and growth maintenance compositions is done at a level between about 25-50 gallons/acre, but is adjusted so that the spray applied coats foliage, but avoid dripping.

Those of ordinary skill in the art will appreciate that materials (e.g., nitrogen sources, gibberellin sources, nutrient sources, innoculum, etc.) and methods (e.g., application methods) other than those specifically exemplified herein can be applied to the practice of this invention without resort to undue experimentation. Art-known equivalents of materials and methods exemplified herein are intended to be encompassed by this invention. Every formulation or combination of components described or exemplified can be used to practice the invention, unless otherwise stated.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, can be exchanged with “consisting essentially of” or “consisting of.”

Whenever a range is given in the specification, for example, a temperature range, a time range, or a composition range, all intermediate ranges and subranges, as well as all individual values included in the ranges given are intended to be included in the disclosure.

Although the description herein contains many specificities, these should not be construed as limiting the scope of the invention, but as merely providing illustrations of some of the embodiments of the invention.

All references cited herein are hereby incorporated by reference in their entirety. All patents and publications mentioned in the specification are indicative of the levels of skill of those skilled in the art to which the invention pertains. References cited herein are incorporated by reference herein in their entirety in part to indicate the state of the art as of their filing date and it is intended that this information can be employed herein, if needed, to exclude specific embodiments that are in the prior art. References cited are also incorporated by reference herein to provide details concerning additional materials, methods and devices useful in the practice of the invention.

I claim:

1. A method for revegetation or remediation of a land surface in need of such revegetation or remediation comprising the steps:
(a) applying a layer containing a selected composition of grain seed, grass seed or both, mulch, and selected nutrients to the land surface;
(b) periodically applying to the layer a growth stimulating composition which comprises one or more plant growth factors;
(c) periodically applying to the layer a growth maintenance composition which comprises nitrogen, but no plant growth factors;
wherein the application of step (a) is repeated until a desired level of surface coverage of growing grain, grass or both is achieved and wherein steps (b) and (c) are repeated on an alternating basis to achieve a desired level of growth.

2. The method of claim 1 wherein the grain seed applied to the land surface is applied at a rate of 100 lbs/acre or more.

3. The method of claim 1 wherein the seed mixture predominantly contains native grass seed.

4. The method of claim 2 wherein the seed mixture predominantly contains native grass seed.

5. The method of claim 1 wherein the grain seed applied is barley seed.

6. The method of claim 2 wherein the grain seed applied is barley seed.

7. The method of claim 1 wherein the grain seed is combined with native grass seed.

8. The method of claim 2 wherein the grain seed is combined with native grass seed.

9. The method of claim 1 wherein the application step (a) is repeated two or more times.

10. The method of claim 1 wherein the layer applied in step (a) comprises one or more gibberellins, one or more humates or a mixture thereof.

11. The method of claim 1 wherein the growth stimulating composition comprises one or more gibberellins.

12. The method of claim 1 wherein the mulch comprises straw, hay or cut native grass.

13. The method of claim 2 wherein the mulch comprises straw, hay or cut native grass.

14. The method of claim 13 wherein the seed mixture contains native grass seed and grain seed.

15. The method of claim 14 wherein the growth stimulating composition comprises one or more gibberellins.

16. The method of claim 15 wherein the application step (a) is repeated two or more times.

17. The method of claim 16 wherein the layer applied in step (a) is sprayed as a hydromulch.

18. The method of claim 1 wherein the layer applied in step further comprises seed and/or seedlings of trees or shrubs.

19. The method of claim 1 wherein the layer applied in step (a) is sprayed as a hydromulch.

20. The method of claim 1 wherein the layer applied in step (a) further comprises seaweed.
